(19) United States
(12) Patent Application Publication
(10) Pub. No.: US 2022/0346432 A1
(43) Pub. Date: Nov. 3, 2022

(54) FOOD PREPARATION/ ASSEMBLING DEVICE

(71) Applicant: Mr. Bar-B-Q Products LLC, Melville, NY (US)

(72) Inventors: Marc Zemel, Melville, NY (US); Joanne Rudis, Melville, NY (US)

(21) Appl. No.: 17/245,441

(22) Filed: Apr. 30, 2021

(51) Int. Cl. A23P 20/20

(52) U.S. Cl. CPC A23P 20/20

(57) ABSTRACT

A food preparation or assembling device having a first member and second member configured to connect to each other and defining an open position and a closed position. The first member has a first base wall and a first peripheral wall extending away from the first base wall, where the first base wall and the first peripheral wall define a first pocket therebetween. The second member has a second base wall and a second peripheral wall extending away from the second base wall, where the second base wall and the second peripheral wall define a second pocket therebetween; and a movable tab disposed about one of the first member or the second member and configured to move from a first position to a second position.

### TECHNICAL FIELD

This disclosure relates to a food preparation and assembling device, particularly to a food preparation device configured to aid in the preparation of a sandwich-like food.

### BACKGROUND

A sandwich-like food configuration may be formed with any food where ingredients are arranged in layers. Generally, food having a sandwich-like arrangement may include a combination of food ingredients, including hot food ingredients and/or cold food items. These food ingredients may be raw or cooked. For food with a sandwich-like configuration and hot food items, these hot food items are generally difficult to handle due to their temperature. Because these food items can get very hot, handling these food items with precaution is essential, especially to avoid burning of your fingers or hands.

It becomes even more difficult to handle a hot food item when the food item is an ingredient that may go under deformation, such as cheese or marshmallows, which can melt with heat and pressure.

Marshmallows are food items which come in all different shapes and sizes and are well known and loved by most of the public in general, especially by kids and campfire goers. One of the reasons the public loves marshmallows is that marshmallows can be deformed, which means that during heat application, which may be delivered via a flame of fire from a hot source such as a stove, a lighter, a firepit, or the like, the marshmallows melt, becoming crispy on the outside and having a toasted nutty-like flavor. When heated, a marshmallow deforms in shape and keeps melting until the application of heat stops or the heat encompassing (or retained by) the marshmallow dissipates; the same can be said about cheese. In addition to the melting properties, heating of a marshmallow may release flavors in a way that does not occur when you eat it cold. Marshmallows are generally used to prepare s'mores, a type of food item having a sandwich-like configuration.

A s'more is known as a campfire treat, generally served as a dessert in which a roasted marshmallow is sandwiched between two pieces of crackers together with at least one piece of chocolate. S'mores, originally called a “graham cracker sandwich in the early 1920's, is a contraction of the phrase “some more,” as may have been chanted at a campfire in the statement “I want s'more.”

Traditionally, s'mores have been a treat prepared on campfires, camping trips, backyard gatherings and similar events and venues. S'more makers usually scrounge the ground surrounding the venue where the s'more is about to be prepared (e.g., campsite or backyard) looking for elongated wand-like elements such as long sticks suitable for skewering one or more marshmallows. The marshmallow-bearing end is then disposed above a campfire and is typically rotated until it browns or catches fire. When preparing s'mores, each camper's technique and skill will vary, and the results are usually unpredictable, especially when it comes to how the marshmallow will behave during melting. Generally, the goal of a smore's assembler is to heat the marshmallow until it becomes soft inside while avoiding a skin burn. The softened marshmallow can then be taken off from the stick and be placed between two crackers to form a smores, or sandwich-like treat.

There have been multiple techniques for assembling s'mores. However, alternatives to traditional approaches for putting together a sandwich-like food or treat is desired.

### SUMMARY

In one aspect, in accordance with the principles of the present disclosure, a food assembling device is provided for the preparation of a sandwich-like type of food.

In aspects, the food assembling device includes a first member and second member configured to be connected one to another and defining an open position and a closed position. The first member has a first base wall and a first peripheral wall extending away from the first base wall, where the first base wall and the first peripheral wall define a first pocket therebetween. The second member includes a second base wall and a second peripheral wall extending away from the second base wall, where the second base wall and the second peripheral wall define a second pocket therebetween. The food assembling device has a movable tab disposed about one of the first member or the second member, the movable tab is configured to move from a first position to a second position and to retain a food ingredient between the tab and the member which it is disposed about.

In aspects, the first member and the second member are operatively hinged or the second member is configured as a cap or is snap fit which removably couples to the first member.

In aspects, the first peripheral wall and the second peripheral wall are configured to engage one against the other when the food assembling device is in a closed position.

In aspects, the first peripheral wall rests above the second peripheral wall or at least a portion of the first peripheral wall encompasses at least a portion of the second peripheral wall.

In aspects, the movable tab is configured to avoid obstructing the engagement of the first peripheral wall with the second peripheral wall.

In aspects, the food assembling device has at least one opening disposed about the first member or the second member.

In aspects, the at least one opening is a recess defined along the one or the two peripheral walls selected from the first peripheral wall or second peripheral wall.

In aspects, the first peripheral wall includes four first sides in a substantially rectangular configuration and the second peripheral wall includes four second first sides in a substantially rectangular configuration.

In aspects, the second peripheral wall includes a tab recess configured for movement of the movable tab.

In aspects, the food assembling device has a lip including a tab opening configured for movement of the movable tab, wherein the lip is connected to the first member or the second member and the tab opening is in fluid communication with the tab recess.

In aspects, the lip is substantially C-shaped, and the tab recess and the tab opening are substantially rectangular.

In aspects, the tab is a rectangular tab connected to the second member via a fastener which is configured to fit though a fastener receiving opening of the movable tab and a corresponding fastener opening of the second member, the fastener opening of the second member is disposed about the tab recess of the second peripheral wall.

In aspects, the lip, the second peripheral wall, the second base wall, and a first hinge portion are monolithically formed.

In aspects, the first peripheral wall, the first base wall, and a second hinge portion are monolithically formed, and the second hinge portion is configured to operably engage the first hinge portion.

In aspects, the hinge portion is a cylindrical conduit operably connected to a similar second hinge portion via a dowell pin, the first hinge portion protrudes away from a first lateral wall of a rectangular first peripheral wall in a direction parallel to the first base wall and away from the first pocket and the second hinge portion protrudes away from a second lateral wall of a rectangular second peripheral wall, which is corresponding to the first lateral wall, in a direction parallel to the second base wall and away from the second pocket.

In aspects, the movable tab is configured to rotate perpendicular to a base wall of a member to which the movable tab is connected to in a clockwise or counterclockwise direction.

In aspects, the second peripheral wall includes a tab recess configured for passing of the movable tab.

In aspects, the lip is configured to encompass at least a portion of the first peripheral wall when the second peripheral wall engages the first peripheral wall.

In aspects, the food assembling device may include a plurality of food positioning elements disposed within the first pocket or second pocket selected from the first member or the second member.

In aspects, the food assembling device is one of two food assembling devices configured to be connected to one another.

In aspects, the food assembling device has a second movable tab connected to the second member, a first divider configured to divide the first pocket into at least two first pockets and including a recess, and a second divider configured to divide the second pocket into two second pockets.

In aspects, a method of assembling and layering food ingredients to make a sandwich-like food or treat may include providing a food assembling device including a first member and a second member operably hinged to one another or including a second member configured as a cap which removably couples to the first member. Each member, first and second, may define corresponding pockets and the second member may include a movable tab.

In aspects, the method includes securing a first food ingredient between the movable tab and a second pocket of the second member.

In aspects, the method includes disposing at last a second food ingredient into a first pocket of the second member.

In aspects, the method includes closing the food assembling device by bringing the second member closer to the first member or to a position where the first food member is disposed substantially above the second food member.

In aspects, the method includes rotating the movable tab to disengage the first food ingredient from the second member to allow the first food ingredient to abut against the second ingredient or any food ingredient disposed above the second food ingredient.

In aspects, the method includes opening the food assembling device by moving the second member away from the first member to access the ingredients which are disposed in layers or at least engaging with one another.

### BRIEF DESCRIPTION OF THE DRAWINGS

The present disclosure will become more readily apparent from the specific description accompanied by the following drawings, in which:

FIG. 1 is a plan view illustrating an exemplary embodiment of a food preparation device encompassing food items; and

FIG. 2 is a perspective view illustrating an exemplary sequence of the method for using the food preparation device of FIG. 1, wherein two food preparation devices are connected to each other.

### DETAILED DESCRIPTION

The present disclosure may be understood more readily by reference to the following detailed description of the disclosure taken in connection with the accompanying drawing figures, which form a part of this disclosure. It is to be understood that this disclosure is not limited to the specific devices, methods, conditions, or parameters described and/or shown herein, and that the terminology used herein is for the purpose of describing embodiments by way of example only and is not intended to be limiting of the claimed disclosure. Also, as used in the specification and including the appended claims, the singular forms “a,” “an,” and “the” include the plural, and reference to a particular numerical value includes at least that value, unless the context clearly dictates otherwise. Ranges may be expressed herein as from “about” or “approximately” one value and/or to “about” or “approximately” another value. When such a range is expressed, another embodiment includes from the one value and/or to the other value. Similarly, when values are expressed as approximations, by use of the antecedent “about,” it will be understood that the value forms another embodiment. It is also understood that all spatial references, such as, for example, horizontal, vertical, top, upper, lower, bottom, left and right, are for illustrative purposes only and can be varied within the scope of the disclosure. Moreover, as used in the specification and including the appended claims words like “item” or “ingredient” and their respective plural forms, when referring to food, may be considered as synonyms.

In general, the present disclosure provides a device and method for preparing or assembling food in a sandwich-like configuration, where ingredients may be presented in a stacked arrangement, for example, food with ingredients stacked one on top of another in an orderly pile, especially one arranged in layers. It is understood that the food preparation device may be configured to handle cold or hot food ingredients. In addition, the device of the present disclosure may include features that may aid to securely handle hot ingredients. Thus, the food assembling device may include or may be fully manufactured with heat resistant materials, for example, heat resistant plastic, rubber, resins, or silicone. In some aspects, the food assembling device may manufactured from metal such as aluminum, iron, or the like. In aspects, the food assembling device may include a combination of plastics and metals. In aspects, the food assembling device may be manufactured via know manufacturing methods such as molding, additive manufacturing (e.g., 3D printing), and or may be formed of a single or a plurality of elements.

The device and method of the present disclosure may be used to prepare or assemble sandwich-like food or treats, for example, the above noted s'mores sandwich. As such, the food preparation or assembling device will be described as a s'more's preparation device for brevity. However, it is understood that the food preparation and assembling device may be used to prepare other types of food that may involve a sandwich-like configuration or ingredients that may need to be arranged in layers, such as a burger, a ham sandwich, a cracker and cheese sandwich, or the like.

The present disclosure generally provides a food preparation or assembling device 1000 configured to prepare a sandwich-like food or treat. For example, the food preparation device may be a s'more preparation device configured to prepare a s'mores sandwich. The food preparation device 1000 includes first member 1100 and second member 1200, the first member 1100 and the second member 1200 are generally configured to work cooperatively. Additionally, the food preparation device 1000 may include a component configured for retaining a food item about a selected member (1100 and/or 1200). Generally, the food preparation device 1000 may be configured to securely retain a food item relative to the member (1100 and/or 1200) to which the component is connected about. For example, the component may be a tab configured to move such as movable tab 1300.

First member 1100 and second member 1200 can be configured to work cooperatively in the assembly of a sandwich such as a s'more “Sami” (FIG. 2) having marshmallow “M” sandwiched between two crackers “C”. In aspects, s'more “Sami” may also include chocolate “0”. In aspects, first member 1100 and second member 1200 may be operably connected to one another. For example, first member 1100 and second member 1200 may be hinged one to another. It is also contemplated, that first member 1100 and second member 1200 may be operably or removably connected to one another by any fastening means known in the art, such as a spring, a screw, adhesives, flexible plastics, etc. In other aspects, first member 1100 may be configured as a base portion which can fit within second member 1200 configured as a cover or top. In still further aspects, first member 1100 and second member 1200 may be configured as a snap fit combination. In such a configuration, first member 1100 may be configured to engage second member 1200, however, it is also contemplated that the two members (1100 and 1200) may not be coupled to one another (for example, the two members 1100 and 1200 may not be joined by a hinge).

In aspects, where the two members (1100 and 1200) are coupled by being hinged, the food preparation device 1000 may include a hinge 1500 configured to operably connect first member 1100 to second member 1200. Hinge 1500 may enable pivoting of the first member 1100 with respect to the second member 1200, or the other way around, pivoting of the second member 1200 with respect to the first member 1100. In aspects, the hinge 1500 may include corresponding cylindrical portions which may be disposed respectively about first member 1100 and/or second member 1200.

In further aspects, the first member 1100 and the second member 1200 may define pockets configured to receive food items. For example, the first member 1100 and the second member 1200 may define rectangularly shaped pockets. However, the first member 1100 and/or the second member 1200 may define circular, rectangular, frustoconical, triangular, or other suitable shaped pockets depending on the desired application, such as for example a round or circular shape to assemble a hamburger sandwich. For example, first member 1100 may define a first pocket 1110 and second member 1200 may define a second pocket 1210.

First member 1100 of the food preparation device 1000 may be rectangular and may include a first base wall 1120 and a first peripheral wall 1130 which is connected to the base wall 1120. The first base wall 1120 and the first peripheral wall 1130 may be monolithically formed or coupled to one to another via known fastening methods such as adhesives, screws, and the like. First pocket 1110 may be defined about the first peripheral wall 1130 and the first base wall 1120. In aspects, first member 1100 may further include a first edge 1140 and at least one opening, for example, one opening configured as a recess, such as recess 1150, described in more detail hereinbelow. In aspects, first member 1100 (and/or the second member 1200) may include a plurality of positioning elements 1160 which are configured to aid with the placing of a food ingredient into the first member 1100, for example, a triangular positioning element (not shown) configured to aid with disposal of a cracker “C” about the first pocket 1110. In aspects, the positioning element (not shown) may be rectangular, circular, rhomboidal, or a combination of two shapes for example, a rectangle and triangle shape.

First pocket 1110 may be configured substantially like a rectangular box with a missing wall. For example, first pocket 1110 of the first member 1100 may be encompassed by the first base wall 1120 and the first peripheral wall 1130. The first peripheral wall 1130 may include first lateral walls 1132, 1134, 1136, and 1138 which protrude away or upward from a substantially rectangular base wall such as first base wall 1120. The first peripheral wall 1130 may be disposed about first base wall 1120 with four first lateral walls 1132, 1134, 1136, and 138, protruding away or upward from first base wall 1120 in a substantially perpendicular direction relative to first base wall 1120. In aspects, first peripheral wall 1130 may define a width “W1” which may be constant through first peripheral wall 1130. Alternatively, width “W1” may vary at a selected portion of first peripheral wall 1130, for example, first lateral wall 1132 may have a width slightly larger in size when compared to the width of first lateral wall 1134.

In aspects, first member 1100 may further include an edge such as first edge or flange 1140 and second member 1200 may further include an edge or flange such as second edge 1240. In aspects, first edge 1140 may be considered a portion of first base wall 1120 which extends radially away from first base wall 1120 and/or away from first peripheral wall 1130 in a direction parallel to first base wall 1120 and perpendicular to first peripheral wall 1130. In aspects, second edge 1240 may be a continuation of second base wall 1220 which extends radially away from second base wall 1220 and away from second peripheral wall 1230 in a direction parallel to second base wall 1220 and perpendicular to second peripheral wall 1230.

In aspects, recess 1150 of the food preparation device 1000 may be disposed along first member 1100 although it is contemplated that a recess may be disposed along second member 1200. For example, recess 1150 may be disposed along a portion of the first peripheral wall 1130, such as for example, along first lateral wall 1132. In aspects, recess 1150 may facilitate discharge of an ingredient disposed about first pocket 1110. For example, a user may place a heated marshmallow “M” from an end of a skewer onto cracker “C” disposed within one of the respective pockets 1110 or 1210, as illustrated in FIG. 2 step 410. Accordingly, in aspects, recess 1150 may be configured for passing of a skewer such as skewer “T” Still for example, the user may then close food preparation device 1000 by bringing second member 1200 closer to first member 1100 and then pull skewer “T” away from food preparation device 1000 as the user presses first member 1100 and second member 1200 firmly together, as seen in step 420, leaving marshmallow M within the respective pocket. Thus, a portion of the marshmallow “M” (for example, portion “P”) may be received by recess 1150. In aspects, portion “P” may protrude away from recess 1150 and food preparation device 1000. In further aspects, recess 1150 may be selectively disposed about first member 1100 and/or second member 1200. In aspects, food preparation device 1000 may include a plurality of recesses such as recess 1150 around the peripheral walls of the members.

Second member 1200 of food preparation device 1000 may be rectangular and may include a second base wall 1220 and a second peripheral wall 1230 which is connected to second base wall 1220.

In aspects, second member 1200 may include at least one opening configured to receive a tab, for example, an opening configured as a recess such as tab recess 1250. In aspects, the tab recess 1250 may be disposed about a peripheral wall (for example, a second peripheral wall 1130).

In aspects, second member 1200 may include a plurality of positioning elements 1260 which may be configured to aid with the placing or retention of a food ingredient into second member 1200, for example, a triangular positioning element 1260 configured to aid with disposal and retention of cracker “C” into second pocket 1210. First member 1100 may also include a plurality of positioning elements which may be configured to aid with the placing or retention of a food ingredient into first member 1100, for example, a triangular positioning element configured to aid with disposal and retention of cracker “C” into first pocket 1110.

Second pocket 1210 of second member 1200 may be defined about second peripheral wall 1230 and second base wall 1220. In aspects, second pocket 1210 may be configured substantially like a rectangular box with a missing wall. For example, second pocket 1210 may be encompassed by second base wall 1220 and second peripheral wall 1230. Second peripheral wall 1130 may include second lateral walls 1232, 1234, 1236, and 1238 which may protrude away or upward from a substantially rectangular base wall such as second base wall 1220. Second peripheral wall 1230 is disposed about second base wall 1220 with four second lateral walls 1232, 1234, 1236, and 1238, protruding away or upward from second base wall 1220 in a substantially perpendicular direction relative to second base wall 1220. In aspects, the tab recess 1250 may be disposed about second lateral wall 1234.

In aspects, first pocket 1110 and/or second pocket 1210 (or at least a portion of one of the two) may be dimensioned according to a shape and/or size of a selected food ingredient, for example, second base wall 1220 configured for abutment against cracker “C” which may be substantially flat and with dimensions of about 3 inches by 2.5 inches, or less. In aspects, first pocket 1110 and/or second pocket 1210 may be configured to be circular to enable layering of cracker, cookie or hamburger sandwiches.

In aspects, second peripheral wall 1230 (or at least a portion thereof) may be configured to engage first peripheral wall 1130. For example, second peripheral wall 1230 may be configured to sit onto first peripheral wall 1130 in such a way that second lateral wall 1232 engages first lateral wall 1132, second lateral wall 1234 engages first lateral wall 1134, second lateral wall 1236 engages first lateral wall 1136, and second lateral wall 1238 engages first lateral wall 1138. In aspects, second peripheral wall 1230 may be similar in size and shape as first peripheral wall 1130. In aspects, second peripheral wall 1230 may be monolithically formed with first base wall 1120. Alternatively, second peripheral wall 1230 may be connected to first base wall 1120 via any known fasting methods, for example, via adhesive or glue, screws, hinges, snaps, Velcro, and the like. In aspects, second peripheral wall 1230 may be configured to engage first peripheral wall 1130, for example, to sit above one another, or snap fit one into another. Alternatively, one of the two first peripheral wall 1130 or second peripheral wall 1203 may be slightly offset with respect to the other. For example, second peripheral wall 1230 (or a portion thereof) may be configured to encompass first peripheral wall 1130, alternatively, first peripheral wall 1130 (or a portion thereof) may be configured to encompass second peripheral wall 1130. In aspects, second peripheral wall 1230 may define a width “W2” which may be constant through second peripheral wall 1230. Alternatively, width “W2” may vary at a selected portion of peripheral wall 1230, for example, second lateral wall 1232 may have a width slightly larger in size when compared to the width of second lateral wall 1234.

In aspects, second peripheral wall 1230 may be configured to receive movable tab 1300 and may include features that may enable connection of the movable tab 1300 thereof. For example, second member 1200 may include a fastener receiving opening 1270 which may be disposed about tab recess 1250. In aspects, tab recess 1250 may be substantially rectangular. Alternatively, and/or additionally, a portion of second member 1200 may be configured for connecting to movable tab 1300, for example, second base wall 1220. For example, fastener receiving opening 1270 may be disposed slightly offset relative to a portion of second peripheral wall 1230 and connected to second lateral wall 1238 adjacent to first pocket 1110. In aspects, fastener receiving opening 1270 may be disposed about a second member protrusion 1280 which may be monolithically formed with the second member 1200 and may be disposed about second peripheral wall 1230 and/or second base wall 1220.

The movable tab 1300 may be selectively disposed about first member 1100 and/or second member 1200. In aspects, first member 1100 and/or second member 1200 may include a plurality of movable tabs. In some aspects, movable tab 1300 may be connected to first member 1100 and/or second member 1200 via a fastener 1310. In aspects, fastener 1310 may be a dowel pin, a screw, or the like. Tab opening 1340 and/or a fastener receiving opening 1270 may be configured to receive the fastener 1310. In aspects, tab opening 1340 and the fastener receiving opening 1270 may be tubular with a similar diameter or rectangular or any shape to accommodate the shape of movable tab 1300. In further aspects, tab opening 1340 and fastener receiving opening 1270 may be configured for fluid communication. Tab opening 1340 may be disposed along movable tab 1300. For example, tab opening 1340 may be defined about a tab protrusion 1350 which extends away from movable tab 1300. Tab protrusion 1350 and movable tab 1300 may be monolithically formed. In aspects, tab protrusion 1350 may be configured to engage second member protrusion 1280. Movable tab 1300 may be configured to pivot relative to the fastener 1310, for example, movable tab 1300 may be configured to rotate in a clockwise and/or anti-clockwise in a direction parallel to second base wall 1220 and relative to fastener 1310. Alternatively, movable tab 1300 may be fixed relative to the members 1100 and/or 1200 to which movable tab 1300 is connected. In aspects, movable tab 1300 may be configured as a resilient clip or a sliding tab.

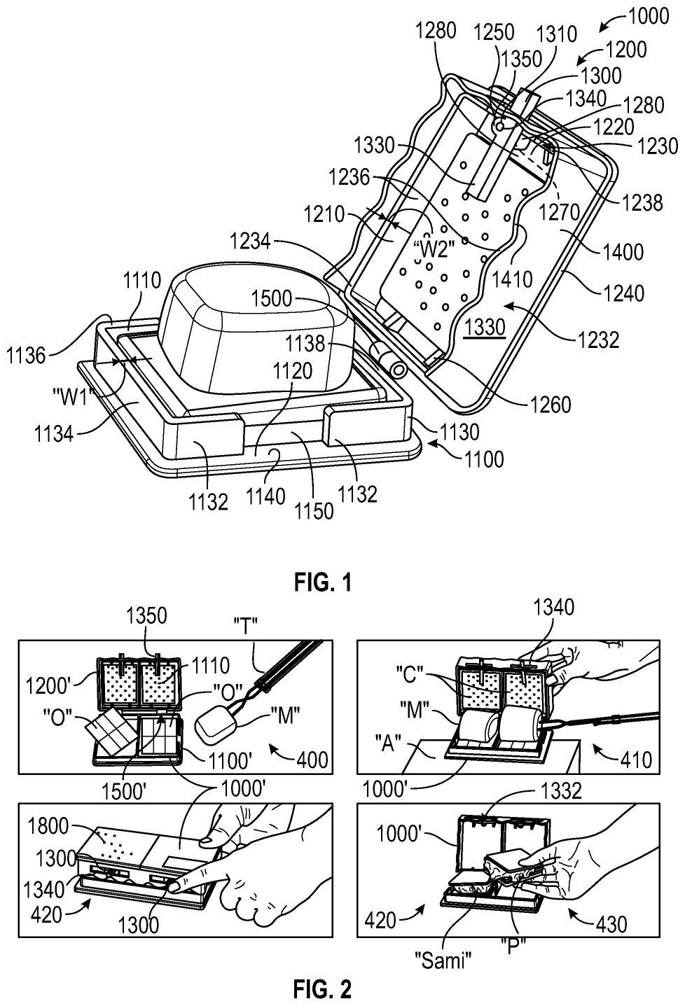

Movable tab 1300 may be elongated with a substantially rectangular shape. In aspects, movable tab 1300 may be U-shaped, J-shape, or circular. In aspects, movable tab 1300 may include a T-shape configuration where movable tab 1300 and the fastener 1310 may be monolithically formed. In general, movable tab 1300 may be configured to retain a food ingredient, for example, cracker “C” in one of the first or second pockets 1110, 1120. In aspects, movable tab 1300 may be configured to move relative to one of the members 1100 and/or 1200 to which movable tab 1300 is connected. For example, movable tab 1300 may be connected to second member 1200 and may be configured to retain a food ingredient (cracker “C”) within second pocket 1210. As exemplary shown in FIG. 1, movable tab 1300 is connected to second peripheral wall 1230 and is configured to retain a substantially flat food ingredient between movable tab 1300 and second base wall 1200.

Movable tab 1300 may be defined in at least two positions. For example, movable tab 1300 may be disposed at a first position 1330 as shown in FIG. 1. In aspects, first position 1330 may be a position where at least a portion of movable tab 1300 is disposed within second pocket 1210, or first pocket 1110 if attached to first member 1100. In aspects, first position 1330 may be a position where at least a portion of movable tab 1300 is disposed in the exterior or second pocket 1210, and/or the first pocket 1110 if attached to first member 1100. In aspects, first position 1330 may be a position relative to a portion of second peripheral wall 1130, for example, first position 1330 may be defined between the 3 o'clock and 9 o'clock positions of a clock, where the 3 o'clock and 9 o'clock positions are substantially aligned with second lateral wall 1238 of second peripheral wall 1230. In aspects, movable tab 1300 may be disposed at a second tab position 1332 as illustrated in step 410 of FIG. 2. Second tab position 1332 may include moving movable tab 1300 at any position where movable tab 1300 may not retain a food ingredient relative to one of the members to which the tab is connected, first and/or second members 1100, 1200. In aspects, second tab position 1332 may include movement of movable tab 1300 at a position substantially parallel to a portion of second peripheral wall 1230, for example, parallel to second lateral wall 1238. In aspects, tab portion 1350 of movable tab 1300 may extend away from tab opening 1340 in a direction away from second pocket 1210, with movable tab 1300 disposed at first position 1330.

In aspects, food preparation device 1000 may include a lip 1400. Lip 1400 may be selectively connected to first member 1100 and/or to second member 1200. For example, lip 1400 may protrude away from second peripheral wall 1230 and/or may protrude away from second edge 1240. In aspects, lip 1400 may protrude away from selected portions of second peripheral wall 1230. For example, lip 1400 may protrude away from second lateral walls 1232, 1236, and 1238 in a direction perpendicular to second base wall 1220. In aspects, lip 1400 may have a C-shape, an L-shape, or other suitable cross-sectional shape. In aspects, lip 1400 may define an end 1410 which may include a plurality of curves. In some aspects, when second member 1200 is connected to first member 1100 or disposed at a position substantially perpendicular to first member 1100 near thereof, at least a portion of lip 1400 may be configured to encompass at least a portion of first peripheral wall 1130, as illustrated in step 420 in FIG. 2.

In some aspects, food preparation device 1000 may include a first plurality of protrusions (not shown) which may extend away from first base wall 1120 in a direction opposing first pocket 1110. In aspects, food preparation device 1000 may include a plurality of second protrusions (not shown) which may extend away from second base wall 1220 in a direction opposing second pocket 1210. In aspects, the first plurality of protrusions (not shown) and/or the second plurality of protrusions (not shown) may be provided to create friction between a surface and the food preparation device 1000, for example, to minimize movement.

In aspects, at least a portion of first member 1100 and/or second member 1200 may be configured to resemble a cracker, for example, at least a portion of first base wall 1200 may be flat and may include features which one may see in a cracker, for example, some crackers have holes through their body and other have patterns such as a plurality of openings or circular shaped recesses, similar to circular shaped recesses 1800 best seen in FIG. 2.

In aspects, food preparation device 1000 may be one of a plurality of food preparation devices 1000 connected to each other. For example, as shown in FIG. 2, two food preparation devices 1000 are monolithically formed and disposed adjacently to one another. In aspects, two first members 1100 may be connected to one another to form first member 1100′ and/or two second members 1200 may be connected to one another to form second member 1200′. In aspects, two first members 1100 may be monolithically formed, for example, molded as a unitary piece during manufacturing. Still in aspects, two second members 1200 may monolithically formed, for example, molded as a unitary piece during manufacturing. Alternatively, selected members may be connected to one another by known fastening methods, for example, glued, bolted, screwed, hinged, or clamped to one another. In aspects, first member 1100′ may be operably hinged to second member 1200′ via a hinge 1500′ or a plurality of hinges 1500. A device including first member 1100′ operably hinged to second member 1200′ via a hinge 1500′ is presented as food preparation device 1000′ in FIG. 2.

In use, first member 1100′ of the food preparation device 1000′ may be coupled to second member 1200′ of the food preparation device 1000′, for example, operably hinged one to another via hinge 1500′. As noted above, first member 1100′ may be two first members 1100 coupled to one another, thus and for reasons of brevity, is understood that first member 1100′ may include two elements for each one element described above with reference to first member 1100. Moreover, second member 1200′ may be two second members 1200 coupled to one another, thus and for reasons of brevity, is understood that the second member 1200′ may include two elements for each one element described above with reference to second member 1200. Thus, additional elements will not be described in detail or may be noted with the same label as the label used in the above description of the selected additional element. For example, first member 1100′ may be referred as including two first pockets 1100, in contrast to a description that may refer to a first pocket 1100′ and a second pocket 1200′.

Still with reference to using food preparation device 1000′, a user may be provided with two food preparation device 1000 coupled to one another where the user may have the option of preparing one or two sandwiches, as seen in FIG. 2. In aspects, with first member 1100′ coupled to second member 1200′, a user may dispose at least one cracker “C” about first member 1100′ and at least one cracker “C” about second member 1200′. For example, a user may dispose cracker “C” into first pockets 1110 and second pockets 1210 of food preparation device 1000′. When preparing two s'more sandwiches, after each cracker “C” is received within first member 1100′ and second member 1200′, the user may manipulate movable tabs 1300 to hold the corresponding cracker “C” into each respective first pocket 1110 and second pocket 1210. For example, the user may rotate movable tabs 1300 from second tab position 1332 as shown in Step 430 to a first tab position 1330 as shown in Step 400.

In aspects, after cracker “C” is received and secured about first member 1100′ in such a way that cracker “C” lays flat against second base wall 1220 and between positioning elements 1260, as shown in FIG. 1. With movable tabs 1300 disposed at second position 1330, as seen in step 400, the user may dispose at least a second ingredient between first member 1100′ and second member 1200′. For example, the user may dispose chocolate “0” about first pocket 1110, shown in step 400, and/or marshmallow “M” in second pocket 1200 and/or above cracker “C” disposed about first member 1100′, as shown in step 410. In aspects, prior to disposing marshmallow “M” within food preparation device 1000, the user may heat marshmallow “M”, for example, roasting marshmallow “M” over a flame. In aspects, marshmallow “M” may be placed at the edge of skewer “T” by piercing marshmallow “M” with skewer “T”'s piercing end, heated over a flame to toast marshmallow “M”, and once roasted, marshmallow “M” may be placed on food preparation device 1000, for example, between two crackers “C” disposed within respective pockets 1110 and 1120 of food preparation device 1000 to form a s'more “Sami”. The user may secure s'more “Sami” about food preparation device 1000, for example, as seen in step 420.

In aspects, after all the selected ingredients are disposed within food preparation device 1000′, the user may fold or close first member 1100′ onto second member 1200′ or vice versa, or may move both members towards each other, to press all the ingredients together to form a sandwich-like food, i.e., a s'mores sandwich. For example, the user may manipulate second member 1200′ in such a way that second member 1200′ pivots relative to hinge 1500′, like a closing door, as illustrated in steps 410 and 420 of FIG. 2. It is understood that these steps may be achieved with the food preparation device 1000′ abutting against surface “A”, such as a table surface or a user's hand. It is understood that surface “A” may be a hand, the user with two hands may manipulate first member 1100′ with one hand and second member 1200′ with the remaining hand.

In aspects, during step 420, the user may facilitate removal of the stacked or formed sandwich by manipulating movable tab 1300. Generally, removal of the sandwich is facilitated by moving movable tab 1300 from first position 1330 (FIG. 1, and step 400 in FIG. 2) to second position 1332, as shown in step 430 in FIG. 2, for example, by pressing on a portion of movable tab 1300 that extends away from second member 1200′, as seen in step 420, until movable tab 1300 is disposed at second tab position 1332. The user may then remove the sandwich away from the food preparation device 1000, by transitioning second member 1200′ from a position substantially parallel to first member 1100′ (step 420) towards a position substantially perpendicular to first member 1100′ (see steps 420 and 430). Finally, the user may remove the sandwich with pressed ingredients away from the food preparation device 1000′, as seen in step 430, to consume.

It will be understood that various modifications may be made to the embodiments disclosed herein. Therefore, the above description should not be construed as limiting, but merely as exemplification of the various embodiments. Those skilled in the art will envision other modifications within the scope and spirit of the claims appended hereto.

What is claimed is:

1. A food assembling device comprising:
a first member and second member configured to connect to each other and defining an open position and a closed position;
the first member including a first base wall and a first peripheral wall extending away from the first base wall, wherein the first base wall and the first peripheral wall define a first pocket therebetween;
the second member including a second base wall and a second peripheral wall extending away from the second base wall, wherein the second base wall and the second peripheral wall define a second pocket therebetween; and
a movable tab disposed about one of the first member or the second member and configured to move from a first position to a second position.

2. The food assembling device of claim 1, wherein the first member and the second member are operatively hinged or the second member is configured as a cap which removably couples to first member.

3. The food assembling device of claim 1, wherein the first peripheral wall and the second peripheral wall are configured to engage one against the other when the food assembling device is in a closed position and the movable tab is configured to retain a food ingredient between the tab and a member.

4. The food assembling device of claim 1, wherein the first peripheral wall rests above the second peripheral wall or at least a portion of the first peripheral wall encompasses at least a portion of the second peripheral wall.

5. The food assembling device of claim 1, wherein the movable tab is configured to avoid obstructing the engagement of the first peripheral wall with the second peripheral wall.

6. The food assembling device of claim 1, further comprising at least one opening disposed about the first member or the second member.

7. The food assembling device of claim 6, wherein the at least one opening is a recess defined along at least one of the peripheral walls selected from the first peripheral wall and second peripheral wall.

8. The food assembling device of claim 1, wherein the first peripheral wall includes four first sides forming a substantially rectangular configuration and the second peripheral wall includes four second first sides forming a substantially rectangular configuration.

9. The food assembling device of claim 1, wherein the second peripheral wall includes a tab recess configured for passing of the movable tab.

10. The food assembling device of claim 1, further comprising a lip including a tab opening configured for passing of the movable tab, wherein the lip is connected to the first member or the second member and the tab opening is in fluid communication with the tab recess.

11. The food assembling device of claim 10, wherein the lip is substantially C-shaped, and the tab recess and the tab opening are substantially rectangular.

12. The food assembling device of claim 9, wherein the movable tab is a rectangular tab connected to the second member via a fastener which is configured to fit though a fastener receiving opening of the movable tab and a corresponding fastener opening of the second member, the fastener opening of the second member is disposed about the tab recess of the second peripheral wall.

13. The food assembling device of claim 10, wherein the lip, the second peripheral wall, the second base wall, and a first hinge portion are monolithically formed.

14. The food assembling device of claim 13, wherein the first peripheral wall, the first base wall, and a second hinge portion are monolithically formed, and the second hinge portion is configured to operably engage the first hinge portion.

15. The food assembling device of claim 14, wherein the first hinge portion is a cylindrical conduit operably connected to the second hinge portion via a dowell pin, the first hinge portion protrudes away from a first lateral wall of a rectangular first peripheral wall in a direction parallel to the first base wall and away from the first pocket and the second hinge portion protrudes away from a second lateral wall of a rectangular second peripheral wall, which is corresponding to the first lateral wall, in a direction parallel to the second base wall and away from the second pocket.

16. The food assembling device of claim 1, wherein the movable tab is configured to rotate perpendicular to a base wall of a member to which the movable tab is connected to in a clockwise or counterclockwise direction.

17. The food assembling device of claim 10, wherein the lip is configured to encompass at least a portion of the first peripheral wall when the second peripheral wall engages the first peripheral wall.

18. The food assembling device of claim 1, further comprising a plurality of food positioning elements disposed within at least one of the first pocket and second pockets.

19. The food assembling device of claim 1, further comprising:
a first divider configured to divide the first pocket into at least two first pockets;
a second divider configured to divide the second pocket into two second pockets; and
a second movable tab disposed in a similar position as the first movable tab within the second pocket of the second member.

20. The food assembling device of claim 1, wherein the food assembling device comprises two food assembling devices configured to be connected to one another to form to pockets in each member.

21. A method of assembling and layering food ingredients to make a sandwich-like food or treat, comprising:
providing a food assembling device including a first member and a second member configured to be coupled to one another to move from an open position to a closed position, each member defining corresponding pockets and at least one member of the first and second members including a movable tab;
securing a first food ingredient between the movable tab and a first pocket;
disposing at least one additional food ingredient into a second pocket;
moving the assembling device first and second members to a closed position;
rotating the movable tab to disengage and layer the first food ingredient from the first pocket onto the at least one additional food ingredient in the second pocket to form the sandwich-like food or treat;
moving the first and second members to an open position assembling device to access the sandwich-like food or treat.
